(19) United States
(12) Patent Application Publication
(10) Pub. No.: US 2011/0234529 A1
(43) Pub. Date: Sep. 29, 2011

(54) TOUCH SCREEN

(76) Inventors: Jong Young LEE, Gyunggi-do (KR); Yong Soo OH, Gyunggi-do (KR)

(21) Appl. No.: 12/794,383

(22) Filed: Jun. 4, 2010

(30) Foreign Application Priority Data
Mar. 29, 2010 (KR) 10-2010-0028058

(51) Int. Cl. G06F 3/045

(52) U.S. Cl. 345/174

(57) ABSTRACT

Disclosed is a touch screen, which includes a window plate made of polyethyleneterephthalate, a transparent electrode formed on one surface of the window plate so that changes in capacitance are sensed and made of a conductive polymer, and a coating layer formed on the other surface of the window plate, and in which the transparent electrode is directly formed on the window plate thus achieving slimness of the touch screen, and the conductive polymer is used as the transparent electrode thus reducing the manufacturing cost and time of the touch screen.

### CROSS REFERENCE TO RELATED APPLICATION

This application claims the benefit of Korean Patent Application No. 10-2010-0028058, filed Mar. 29, 2010, entitled “Touch screen”, which is hereby incorporated by reference in its entirety into this application.

### BACKGROUND OF THE INVENTION

1. Technical Field

The present invention relates to a touch screen.

2. Description of the Related Art

As the electronics technology and information technology have developed, the use of electronic devices in daily life including business environments is increasing continuously. In particular, the continuous growth of electronics technology requires personal computers, portable transmitters and so on which process text and graphics using a variety of input devices including a keyboard, mouse, digitizer, etc. However, because such input devices are developed depending on various needs of personal computers, it is problematic to apply them to portable devices that are riding the recent trend of having a reduced size and thickness. Accordingly, touch screens are receiving attention as input means adapted for portable devices.

The touch screen, which is typically mounted on a display device, senses the touch position on the screen by a user, and thus performs control of the electronic device including the control of the screen of the display based on input information of the sensed touch position. Such touch screens are generally classified as being of a resistive, capacitive, electromagnetic, SAW, or infrared type.

The touch screen is advantageous because it is simple, infrequently operates erroneously, enables space to be saved, and is easy to link with IT devices. Thanks to such advantages, the touch screen is widely utilized in various fields including industry, traffic, service, medical treatment, mobile, etc. Recent attempts are being made to form a touch screen which is thinner and thereby adapted for electronic devices which have miniaturization and slimness.

FIG. 1 is a cross-sectional view showing a conventional touch screen 10. With reference to this drawing, the conventional touch screen 10 is described below.

As shown in FIG. 1, the conventional touch screen 10 includes a window plate 11, a transparent substrate 12, an adhesive layer 13, an indium tin oxide (ITO) electrode 14, electrodes 15, and a hard coating layer 16.

In this touch screen, one surface of the window plate 11 is adhered to one surface of the transparent substrate 12 by means of the adhesive layer 13, and the ITO electrode 14 which recognizes changes in capacitance is formed on the other surface of the transparent substrate 12 using deposition, development and etching. The electrodes 15, which are used to apply voltage to the ITO electrode 14, are formed at the outer periphery of the other surface of the transparent substrate 12 so as to be connected to the ITO electrode 14. The hard coating layer 16 is formed on the other surface of the window plate 11 in order to protect the touch screen 10.

However, the conventional touch screen 10, which includes both the transparent substrate 12 and the window plate 11, is undesirably thick, and thus the flexibility or curvature thereof is reduced, whereby the hard coating layer 16 may be damaged even under small impact.

Furthermore, because the ITO electrode 14 which is expensive is used as the transparent electrode and is formed on the transparent substrate 12 by using deposition, development and etching, there occur problems of the manufacturing process of the touch screen becoming complicated and the manufacturing cost and time of the touch screen increased.

### SUMMARY OF THE INVENTION

Accordingly, the present invention has been made keeping in mind the problems encountered in the related art and the present invention is intended to provide a touch screen, which does not include a transparent substrate thus reducing the thickness of the touch screen, increasing a curvature, and preventing damage to a hard coating layer.

Also the present invention is intended to provide a touch screen which includes a transparent electrode made of a conductive polymer thus reducing the manufacturing cost and time of the touch screen.

An aspect of the present invention provides a touch screen, including a window plate made of polyethyleneterephthalate (PET), a transparent electrode formed on one surface of the window plate so that changes in capacitance are sensed and made of a conductive polymer, and a coating layer formed on the other surface of the window plate.

In this aspect, the coating layer may be a hard coating layer, an anti-finger layer, an anti-glare layer, an anti-reflective layer, or a laminate thereof.

In this aspect, the conductive polymer may be poly-3,4-ethylenedioxythiophene/polystyrenesulfonate (PEDOT/PSS).

In this aspect, both surfaces of the window plate may be subjected to primer treatment.

In this aspect, the touch screen may further include electrodes formed on the window plate and connected to the transparent electrode so as to apply voltage.

In this aspect, the touch screen may further include an adhesive layer formed on one surface of the window plate on which the transparent electrode has been formed, and a display adhered to the window plate using the adhesive layer.

In this aspect, the adhesive layer may be an optical clear adhesive (OCA) or double-sided adhesive tape (DAT).

### BRIEF DESCRIPTION OF THE DRAWINGS

The features and advantages of the present invention will be more clearly understood from the following detailed description taken in conjunction with the accompanying drawings, in which:

FIG. 1 is a cross-sectional view showing a conventional touch screen;

FIGS. 2 and 3 are cross-sectional views showing a touch screen according to an embodiment of the present invention; and

FIG. 4 is a cross-sectional view showing a touch screen including a display according to another embodiment of the present invention.

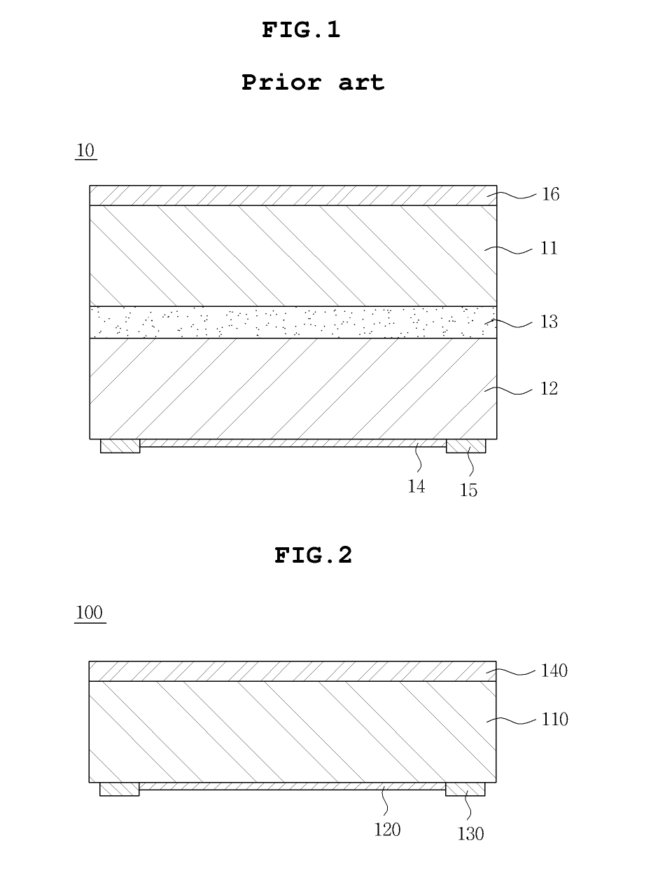

### DESCRIPTION OF SPECIFIC EMBODIMENTS

Hereinafter, embodiments of the present invention will be described in detail while referring to the accompanying drawings. Throughout the drawings, the same reference numerals are used to refer to the same or similar elements. In the description, the terms “first”, “second” and so on are used to distinguish one element from another element, and the elements are not defined by the above terms. Moreover, descriptions of known techniques, even if they are pertinent to the present invention, are regarded as unnecessary and may be omitted when they would make the characteristics of the invention and the description unclear.

Furthermore, the terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept implied by the term to best describe the method he or she knows for carrying out the invention.

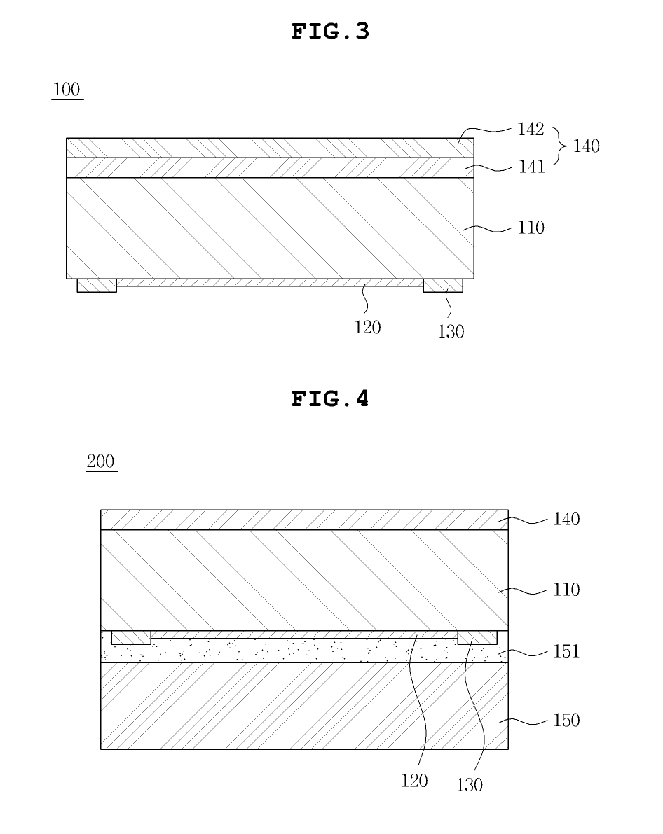

FIGS. 2 and 3 are cross-sectional views showing a touch screen 100 according to an embodiment of the present invention, and FIG. 4 is a cross-sectional view showing a touch screen 200 including a display according to another embodiment of the present invention. With reference to these drawings, the touch screen 100, 200 according to the present embodiment is described below.

As shown in FIGS. 2 and 3, the touch screen 100 according to the present embodiment includes a window plate 110, a transparent electrode 120, electrodes 130, and a coating layer 140. Also, as shown in FIG. 4, the touch screen 200 according to the present embodiment may further include an adhesive layer 151 and a display 150.

The window plate 110 functions to protect the touch screen 100 and to provide a space where the transparent electrode 120 and the electrodes 130 are formed.

The window plate 110 is a member to which a touch input is applied from a specific object such as the body of a user or a stylus pen, and maintains the contour of the input part of the touch screen 100. Thus, the window plate 110 may be made of a material having high durability so as to sufficiently protect the touch screen 100 from external force, and may also be made of a transparent material so that a user can see the display, for example, polycarbonate (PC), polymethylmethacrylate (PMMA), polyethylenenaphthalate (PEN), polyethersulfone (PES), cyclic olefin copolymer (COC), glass or reinforced glass. Particularly useful is polyethyleneterephthalate (PET). In the case where the window plate 110 is provided in the form of a film made of polyethyleneterephthalate (PET), the curvature is increased compared to when using different materials, thus making it possible to manufacture the touch screen 100 in the form of a roll or in a bendable shape.

The transparent electrode 120 is formed on one surface of the window plate 110, and the coating layer 140 is formed on the other surface of the window plate 110. In order to enhance the force of adhesion of the window plate 110 to the transparent electrode 120 and the coating layer 140, both surfaces of the window plate 110 may be subjected to high frequency treatment or primer treatment.

The transparent electrode 120 is directly formed on the window plate 110, and recognizes signals from touch or approach by a specific object.

The transparent electrode 120, which is directly formed on one surface of the window plate 110 without the use of an additional transparent substrate or transparent film, senses changes in capacitance resulting from touch or approach by a specific object such as the body of a user or a stylus pen and transfers the changed value thus sensed to a controller (not shown). The controller (not shown) simultaneously converts analog signals into digital signals and recognizes the coordinates of the pressed position, thus executing the desired operation. Specifically, voltage is applied by the electrodes 130 so that high frequency is spread across the entire surface of the transparent electrode 120. Thereafter, upon touch or approach to the touch screen by the body of a user or the like, predetermined changes in capacitance occur and are sensed by the transparent electrode 120 acting as an electrode and the window plate 110 acting as a dielectric, and the touch position or whether touch was generated may be recognized from the changed waveform thus sensed by the controller (not shown).

The transparent electrode 120 is formed of a transparent material so that a user sees the display 150 which is disposed at the lower portion of the touch screen, and may be made of a conductive material. For example, the transparent electrode 120 may be made of a conductive polymer composed of one or more selected from among poly-3,4-ethylenedioxythiophene/polystyrenesulfonate (PEDOT/PSS) and polyaniline.

As such, in the case where the transparent electrode 120 is made of a conductive polymer, it may be formed on the window plate 110 using silk screen printing, ink jet printing, gravure printing, or offset printing. For example, the formation of the transparent electrode 120 using silk screen printing may be performed by tightly stretching a screen under strong tension, applying an ink paste made of a conductive polymer on the screen, and pressing the paste using a squeegee so that the paste is transferred onto the surface of the window plate 110 through the meshes of the screen. As mentioned above, silk screen printing is simpler compared to the deposition, development and etching conventionally used to form an ITO electrode, and enables direct application onto the window plate 110 thus saving the material. Hence, the process cost and time of the touch screen 100 may be reduced.

Moreover, the transparent electrode 120 is directly integrated on the window plate 110 thus obviating an additional transparent substrate, whereby the touch screen 100 may be manufactured to be thin, and it is possible to manufacture a touch screen 100 in the form of a roll or in a bendable shape. Also, in the case where the window plate 110 is made of polyethyleneterephthalate (PET), the curvature is further increased, thus preventing damage to the coating layer 140. Also, because the attachment of an additional transparent film is not needed, foam or scratches occurring upon attachment of a transparent film may be prevented in advance.

The transparent electrode 120 may be provided in the form of a bar, lozenge, hexagonal, octagonal, or triangular shape. As such, in the case where the transparent electrode 120 is provided in the form of not two layers but a single layer, the pattern of the X-axis and the pattern of the Y-axis may be connected through a bridge.

The electrodes 130 are electrically connected to the transparent electrode 120 thus supplying voltage to the transparent electrode 120.

The electrodes 130 are formed of a material having high electrical conductivity so as to supply voltage to the transparent electrode 120. For example, the electrodes 130 may be made of a silver (Ag) paste or organic Ag. Also, the electrodes 130 may be made of a conductive polymer or ITO in order to make the electrodes 130 transparent.

The electrodes 130 may be formed on the window plate 110 and connected to the transparent electrode 120 so as to supply voltage to the transparent electrode 120.

The coating layer 140 is formed on the other surface of the window plate 110, that is, as the outermost layer of the touch screen 100, and functions to protect the touch screen 100 and to supplement and improve the functions of the touch screen 100.

The coating layer 140 is for example a hard coating layer, an anti-finger layer, an anti-glare layer, or an anti-reflective layer. Specifically, the hard coating layer may protect the window plate 110 from external impact, and may be formed by applying a hard resin such as acryl, urethane or siloxane on the window plate 110 and then curing it. Also, the anti-finger layer may be formed by applying a coating solution having an anti-finger function on the window plate 110 so as not to remain a fingerprint thereon. Also, the anti-glare layer may be formed by dispersing inorganic particles such as CaCO₃ or SiO₂ in a typical coating layer or roughening the surface of a coating layer in order to prevent the refraction of light. Also, the anti-reflective layer may be formed by mixing a hard resin with a silicone resin and roughening the surface of the mixture in order to prevent reflection resulting from operation of the minor.

The coating layer 140, such as the hard coating layer, the anti-finger layer, the anti-glare layer or the anti-reflective layer, need not be provided only in a single layer, and may be provided in the form of a laminate of two or more layers. For example, as shown in FIG. 3, the coating layer 140 may be provided in the form of a two-layer structure in which the anti-reflective layer 141 is formed on the other surface of the window plate 110 and the hard coating layer 142 is formed on the anti-reflective layer 141.

In addition, as shown in FIG. 4, the display 150 may be further provided on one surface of the window plate 110 on which the transparent electrode 120 has been formed.

The display 150 allows a user to see an image and a reaction when a user touches the touch screen 200. The display 150 may include for example a liquid crystal display (LCD), a plasma display panel (PDP), an electroluminescence (EL) element, or a cathode ray tube (CRT).

In order to adhere the display 150 to one surface of the window plate 110, the adhesive layer 151 is disposed between the display 150 and one surface of the window plate 110. The adhesive layer 151 may be formed at the outer periphery of the display 150 or on the entire surface of the display 150. In the case where the adhesive layer 151 is formed at the outer periphery of the display 150, it is easy to correct the window plate 110 and the display 150 which have been adhered together in a dislocated state. As such, the adhesive layer 151 may be double-sided adhesive tape (DAT). On the other hand, in the case where the adhesive layer 151 is formed on the entire surface of the display 150, an air layer is not formed between the display 150 and the window plate 110, so that the image of the display 150 is transferred to the user without distortion. As such, the adhesive layer 151 may be an optical clear adhesive (OCA).

As described hereinbefore, the present invention provides a touch screen. According to the present invention, the touch screen is advantageous because a transparent electrode is directly formed on a window plate without the use of an additional transparent substrate, and thus the touch screen is thin and has increased flexibility or curvature, thereby preventing damage to a coating layer thereof.

Also, according to the present invention, the transparent electrode is made of a conductive polymer which is relatively inexpensive and is formed on a window plate using screen printing which is simple, thus reducing the process cost and time compared to when using deposition, development and etching.

Also, according to the present invention, because the transparent electrode is directly formed on the window plate, there is no need for an adhesive layer for adhering a transparent substrate, and thus foam and scratches occurring on the adhesive surface can be prevented in advance.

Also, according to the present invention, the window plate is made of polyethyleneterephthalate (PET), thus further increasing the curvature or flexibility of the touch screen.

Also, according to the present invention, a coating layer is formed at the outermost surface of the touch screen, thus protecting the touch screen and supplementing and improving the functions of the touch screen.

Although the embodiments of the present invention regarding the touch screen have been disclosed for illustrative purposes, those skilled in the art will appreciate that a variety of different modifications, additions and substitutions are possible, without departing from the scope and spirit of the invention as disclosed in the accompanying claims. Accordingly, such modifications, additions and substitutions should also be understood as falling within the scope of the present invention.

What is claimed is:

1. A touch screen, comprising:
a window plate comprising polyethyleneterephthalate;
a transparent electrode formed on one surface of the window plate so that changes in capacitance are sensed and comprising a conductive polymer; and
a coating layer formed on the other surface of the window plate.

2. The touch screen as set forth in claim 1, wherein the coating layer is a hard coating layer, an anti-finger layer, an anti-glare layer, an anti-reflective layer, or a laminate thereof.

3. The touch screen as set forth in claim 1, wherein the conductive polymer is poly-3,4-ethylenedioxythiophene/polystyrenesulfonate.

4. The touch screen as set forth in claim 1, wherein both surfaces of the window plate are subjected to primer treatment.

5. The touch screen as set forth in claim 1, further comprising electrodes formed on the window plate and connected to the transparent electrode so as to apply voltage.

6. The touch screen as set forth in claim 1, further comprising:
an adhesive layer formed on one surface of the window plate on which the transparent electrode has been formed; and
a display adhered to the window plate using the adhesive layer.

7. The touch screen as set forth in claim 1, wherein the adhesive layer is an optical clear adhesive or double-sided adhesive tape.
